(19) United States
(12) Patent Application Publication
(10) Pub. No.: US 2005/0064913 A1
(43) Pub. Date: Mar. 24, 2005

(54) Incoming call alerting method and mobile communication terminal using the same

(76) Inventor: Byung-Jin Kim, Seoul (KR)

Correspondence Address: MORGAN & FINNEGAN, L.L.P., 3 World Financial Center, New York, NY, 10281-2101, US

(21) Appl. No.: 10/917,623

(22) Filed: Aug. 13, 2004

(30) Foreign Application Priority Data
Aug. 18, 2003 (KR) 2003-56780

(51) Int. Cl. H04B 7/19

(52) U.S. Cl. 455/567; 455/550.1

(57) ABSTRACT

Disclosed herein is a method for generating incoming call alerting signals depending on motion and a mobile communication terminal using the method. The mobile communication terminal includes a motion detection unit, a memory and a control unit. The motion detection unit outputs a value in proportion to motion of a mobile communication terminal. The memory stores a program that has an algorithm for adjusting a volume of a ring tone or an intensity of vibrations according to an output value of the motion detection unit, and data that is used to execute the program. The control unit performs a function of adjusting the volume of a ring tone or the intensity of vibrations in proportion to a degree of the motion of the mobile communication terminal represented by the output value of the motion detection unit.

### BACKGROUND OF THE INVENTION

1. Field of the Invention

The present invention relates generally to a method for generating incoming call alerting signals depending on motion and a mobile communication terminal using the method, and, more particularly, to a method and a mobile communication terminal using the method, in which the mobile communication terminal is provided with a motion detection unit for detecting the motion of the mobile communication terminal and the volume of a ring tone or the intensity of vibrations is adjusted depending on the detected motion, so that a large volume ring tone or high intensity vibrations are output if a user undergoes a large motion, and a small volume ring tone or low intensity vibrations are output if the user undergoes a small motion, thus allowing a user to take a call or an alarm in a manner suitable for the circumstances of the user.

2. Description of the Related Art

In general, a mobile communication terminal is provided with a function of supporting a ring tone/vibration mode to notify a user of an incoming call and an alarm. That is, the user is notified of the incoming call and the alarm by the above function while holding the mobile communication terminal and carrying out some other work.

The user of a mobile communication terminal may encounter various circumstances. For example, the circumstances may include a crowded subway, an active workplace, and a quiet conference room. Under these circumstances, the user of a mobile communication terminal must manually adjust the volume of a ring tone or the intensity of vibrations by himself or herself so that the user can perceive the ring tone or vibrations. Accordingly, the volume of the ring tone or the intensity of vibrations must be adjusted to places or circumstances when the places or circumstances are changed, so that the user of the mobile communication terminal must suffer inconvenience.

In the meantime, there were attempts to provide a method of detecting a noise level depending on circumstances in a mobile communication terminal and adjusting the volume of a ring tone or the intensity of vibrations according to the detected noise level, and a mobile communication terminal in which the method is implemented. However, a function of detecting the motion of a mobile communication terminal or estimating the state in which the mobile communication terminal is placed, and adjusting the volume of a ring tone or the intensity of vibrations based on the detection or estimation results has not been proposed yet.

### SUMMARY OF THE INVENTION

Accordingly, the present invention has been made keeping in mind the above problems occurring in the prior art, and an object of the present invention is to provide a method of detecting the motion of a mobile communication terminal using a motion detection unit contained in the mobile communication terminal and adjusting the volume of a ring tone or the intensity of vibrations to be suitable for the detected motion of the mobile communication terminal.

Another object of the present invention is to provide a mobile communication terminal, which is provided with a motion detection unit for detecting the motion of the mobile communication terminal so that the user of the mobile communication terminal can adjust the volume of a ring tone or the intensity of vibrations to be suitable for the circumstances of the user.

In order to accomplish the above object, the present invention provides a mobile communication terminal, including a motion detection unit for outputting a value in proportion to the motion of a mobile communication terminal; a memory for storing a program that has an algorithm for adjusting a volume of a ring tone or an intensity of vibrations according to the output value of the motion detection unit, and data that is used to execute the program; and a control unit for performing a function of adjusting the volume of a ring tone or the intensity of vibrations in proportion to a degree of the motion of the mobile communication terminal represented by the output value of the motion detection unit.

In addition, the present invention provides a method of generating incoming call alerting signals depending on motion, including the first step of checking whether an instruction for a call signal or an alarm activation signal exists; the second step of a control unit reading at least one value in proportion to motion of a mobile communication terminal from a motion detection unit if the instruction exists; and the third step of the control unit adjusting the volume of a ring tone according to the value.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram of a mobile communication terminal according to the present invention;

FIGS. 2a and 2b are flowcharts showing processes of measuring the motion of the mobile communication terminal and automatically adjusting the volume of a ring tone or the intensity of vibration, in accordance with the present invention; and

FIG. 3 is a flowchart showing a process of measuring the motion of the mobile communication terminal and automatically switching the mobile communication terminal to a manner mode when a call signal or an alarm activation signal does not exist, in accordance with the present invention.

### DESCRIPTION OF THE PREFERRED EMBODIMENTS

Reference now should be made to the drawings, in which the same reference numerals are used throughout the different drawings to designate the same or similar components.

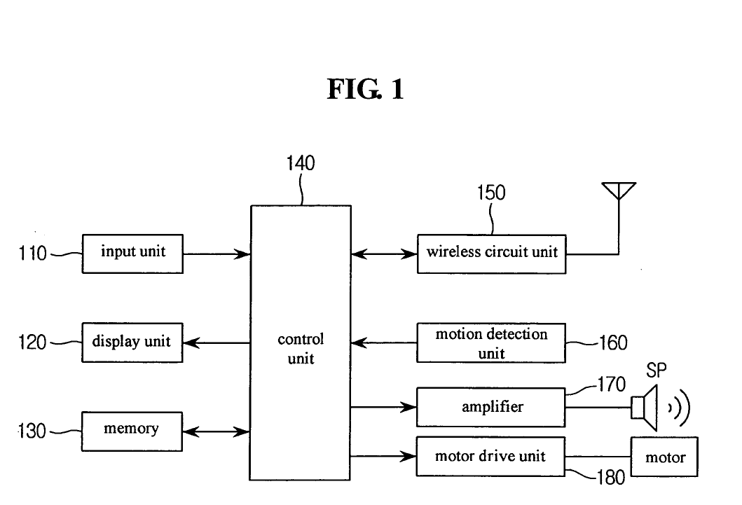

FIG. 1 is a configuration diagram of a mobile communication terminal according to the present invention, which includes an input unit 110, a display unit 120, a memory 130, a control unit 140, a wireless circuit unit 150, a motion detection unit 160, an amplifier 170 and a motor drive unit 180.

Various devices, such as a keypad, a jog shuttle, a point stick and a touch screen, may be used as the input unit 110. The input unit 110 is used while the user selects a desired function or inputs information. In the present invention, the user previously inputs an alarm activation function via the input unit 110.

The display unit 120 is used to display various information to the user. A Liquid Crystal Display (LCD) is chiefly used as the display unit 120.

The memory 130 stores a program and data that are required for the operation of the mobile communication terminal. One of various memory devices, such as Erasable Programmable Read Only Memory (EPROM), Static Random Access Memory (SRAM) and flash memory, may be used as the memory 130. In the present invention, the memory 130 stores a program that has an algorithm of providing a ring tone and vibrations according to a value obtained by a motion detection unit 160 at the time of receiving a call signal or an alarm activation signal. The memory 130 further stores data used to execute the program, and data used and produced by the program.

The control unit 140 functions to control the entire operation of the mobile communication terminal. The control unit 140 may be formed of a microprocessor or a Digital Signal Processor (DSP). In the present invention, the control unit 140 performs a function of measuring the motion of the mobile communication terminal and adjusting the volume of a ring tone and the intensity of vibrations based on the measured motion of the mobile communication terminal, a function of automatically switching the mobile communication terminal to a manner mode, and a function of notifying the user of the volume of a ring tone or the intensity of vibrations using the ring tone or vibrations at the time of receiving a call signal or alarm activation signal.

The wireless circuit unit 150 is a circuit that enables the mobile communication terminal to exchange voice and control information with a base station. The wireless circuit unit 150 functions to receive a call signal, which is transmitted by an external mobile communication terminal, through an antenna and transmit the call signal to the control unit 140, or to transmit data, which is stored in the memory 130, to the mobile communication terminal of a transmitter through the antenna.

The motion detection unit 160 has a function of measuring the motion of the mobile communication terminal. The motion detection unit 160 measures the current posture and motion of the mobile communication terminal and outputs values corresponding to the measured current posture and motion. A gyro sensor may be used as the motion detection unit 160. The gyro sensor is a device for detecting and indicating the motion, acceleration and inclination of an object, and is applied to the motion control of a robot, a car navigation system, a motion tracking system, etc. The present invention detects the motion of the mobile communication terminal using the function of the gyro sensor.

The amplifier 170 functions to output a ring tone via a speaker under the control of the control unit 140.

The motor drive unit 180 functions to drive a motor under the control of the control unit 140.

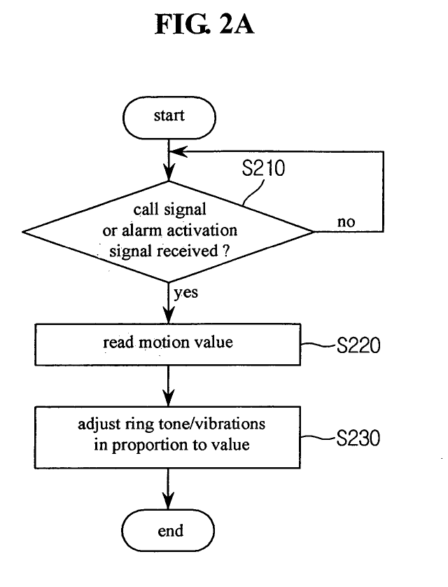

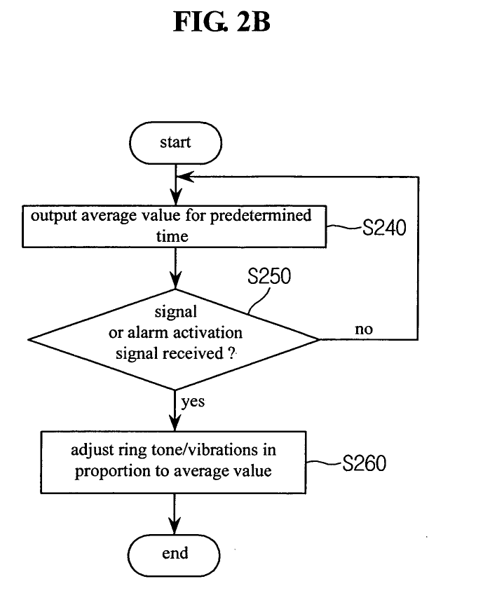

FIGS. 2a and 2b are flowcharts showing processes of measuring the motion of the mobile communication terminal and automatically adjusting the volume of a ring tone or the intensity of vibrations at the time of receiving a call signal or alarm activation signal in accordance with the present invention.

FIG. 2a is described first.

The control unit 140 checks whether a call signal, which has been received through the antenna, exists or whether an alarm activation signal, which has been received through the input unit 110, exists at step S210.

The control unit 140 reads values, which are output by the motion detection unit 160, at the time of receiving the call signal or alarm activation signal at step S220.

The control unit 140 adjusts the volume of a ring tone by adjusting the gain of the amplifier 170, or adjusts the intensity of vibrations by adjusting the output of the motor drive unit 180 at step S230.

In another embodiment, a function of outputting one of various types of ring tones may be added to step S230. That is, various types of ring tones corresponding to the values of the motion of the mobile communication terminal are stored in the memory 130 and a corresponding type of ring tone is output according to the value of the motion of the mobile communication terminal. For example, if a noisy ring tone is set to be output when the motion of the mobile communication terminal is large and a quiet ring tone is set to be output when the motion of the mobile communication terminal is small, an effect similar to that, which is obtained when the volume of a ring tone is adjusted depending on the motion of the mobile communication terminal, can be obtained.

In accordance with the embodiment of FIG. 2a, the control unit outputs a ring tone of a volume or vibrations of an intensity according to the value of the immediately prior motion of the mobile communication terminal when a call signal or alarm activation signal is received. This may cause the output of a ring tone of a volume or vibrations of an intensity unstable for the circumstances of the user. For example, a large volume ring tone can be output depending on the motion of the user in a quiet conference room. In view of this problem, the embodiment of FIG. 2b is proposed.

FIG. 2b is a flowchart showing a process of taking the average of the values of the motion of the mobile communication terminal for a predetermined period of time.

The control unit 140 reads values from the motion detection unit 160 and takes the average of the values for a predetermined period of time at step S240.

The control unit 140 checks whether a call signal, which has been received from the antenna, exists or whether an alarm activation signal, which has been input through the input unit 110, exists at step S250.

When receiving a call signal or an activation signal, the control unit 140 adjusts the volume of a ring tone by adjusting the gain of the amplifier 170 in proportion to a current average value, or adjusts the intensity of vibrations by adjusting the output of the motor drive unit 180 at step S260.

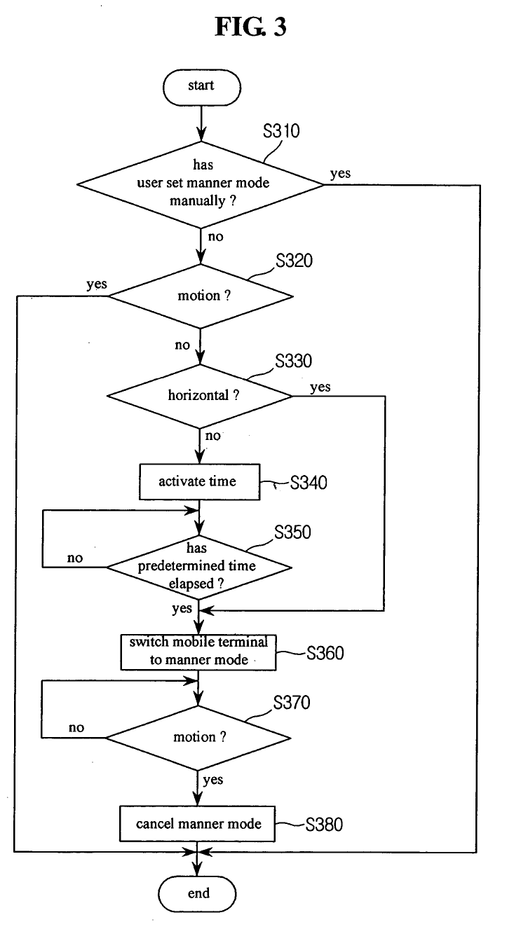

FIG. 3 is a flowchart showing a process of measuring the motion of the mobile communication terminal in idle state and automatically switching the mobile communication terminal to a manner mode if it is determined that the motion of the mobile communication terminal is relatively small, or does not exit in accordance with the present invention.

Since a step of automatically switching the mobile communication terminal to the manner mode is not necessary in the case where the current mode of the mobile communication terminal at a standby state is the manner mode, the control unit 140 checks whether the current mode of the mobile communication terminal is the manner mode at step S310.

If the current mode of the mobile communication terminal is not the manner mode, the control unit 140 detects the motion of the mobile communication terminal and reads an output value. If the motion of the mobile communication exists at the above step, the current mode is maintained, and if the motion of the mobile communication does not exist, the process proceeds to step S330 at step S320.

The control unit 140 causes the mobile communication terminal to be switched to the manner mode if the mobile communication terminal is placed horizontally, and if not, the process proceeds to step S340 at step S330.

The control unit 140 checks whether the predetermined period of time of the timer has elapsed at step S350. If the motion of the mobile communication terminal has not existed while the predetermined period of time has elapsed, the control unit 140 switches the mobile communication terminal to a manner mode at step S360.

If the motion of the mobile communication terminal exists in the manner mode at step S370, the control unit 140 reads a value from the motion detection unit 160, cancels the manner mode and switches the mobile communication terminal to an original mode at S380.

As described above, the present invention evaluates the circumstances of the user by measuring the motion of the mobile communication terminal, and automatically adjusts the volume of a ring tone or the intensity of vibrations depending on the motion of the mobile communication terminal. As a result, the mobile communication terminal can notify the user of the reception of a call by issuing a high output when the user cannot perceive the normal ring tone or vibrations of the mobile communication terminal because the user is in a loud place or in motion. In contrast, the mobile communication terminal can notify the user of the reception of a call through a low output when the user is located in a quiet area. Furthermore, when a large volume ring tone or high intensity vibrations are not necessary as in the case where the motion of the mobile communication terminal exists little or the mobile communication terminal is laid on a desk, the mobile communication terminal is automatically switched to a manner mode, thus preventing mistakes due to a large volume ring tone or high intensity vibrations.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A mobile communication terminal, comprising:
a motion detection unit configured to detect and output a value in proportion to the motion of the mobile communication terminal;
a memory unit configured to store a program that has an algorithm for adjusting a call alerting signal according to the output value of the motion detection unit, and data that is used to execute the program; and
a control unit configured to adjust the call alerting signal in proportion to a degree of the motion of the mobile communication terminal represented by the output value of the motion detection unit.

2. The mobile communication terminal as set forth in claim 1, wherein the motion detection unit is a gyro sensor.

3. The mobile communication terminal of claim 1, wherein the call alerting signal is one of a ring tone and a vibration.

4. A call alerting method of a mobile communication terminal, comprising:
determining whether an instruction for a call alerting signal exists;
detecting at least one value in proportion to the motion of the mobile communication terminal from a motion detection unit if the instruction exists; and
adjusting the call alerting signal according to the at least one value from the detecting.

5. The method as set forth in claim 4, wherein the at least one value in proportion to the motion of the mobile communication terminal is an average of values output from the motion detection unit for a predetermined period of time.

6. The call alerting method of claim 4, wherein the call alerting signal is one of a ring tone and a vibration of the mobile communication terminal.

7. A call alerting method of a mobile communication terminal, comprising:
determining whether an instruction for a call alerting signal exists;
detecting at least one value in proportion to the motion of the mobile communication terminal from a motion detection unit if the instruction exists; and
selecting one of various types of ring tones according to the at least one value from the detecting.

8. The method as set forth in claim 7, wherein the at least one value in proportion to the motion of the mobile communication terminal is an average of values output from the motion detection unit for a predetermined period of time.

9. The call alerting method of claim 7, wherein the call alerting signal is one of a ring tone and a vibration of the mobile communication terminal.

10. A call alerting method of a mobile communication terminal, comprising:
determining whether an instruction for a call alert signal exists;
detecting at least one value in proportion to the motion of the mobile communication terminal from a motion detection unit if the instruction exists;
activating a timer if the motion indicated by the at least one value does not exists; and
switching the mobile communication terminal to a manner mode if it is determined from the activating that a predetermined period of time has elapsed.

11. The method as set forth in claim 10, further comprising:
reading a value from the motion detection unit while the mobile communication terminal is in the manner mode; and
canceling the manner mode if it is determined in the reading that there is a motion in the mobile communication terminal.

12. The method as set forth in claim 10, wherein the at least one value in proportion to the motion of the mobile communication terminal is an average of values output from the motion detection unit for a predetermined period of time.

13. A call alerting method of a mobile communication terminal, comprising:
determining whether an instruction for a call alerting signal exists;
detecting at least one value in proportion to the motion of the mobile communication terminal from a motion detection unit if the instruction exists; and
switching the mobile communication terminal to a manner mode if it is recognized in the detecting that the mobile communication terminal is laid horizontally.

14. The method as set forth in claim 13, further comprising:
reading a value from the motion detection unit if a motion of the mobile communication terminal exists in the manner mode; and
canceling the manner mode if it is determined in the reading that there is the motion exists in the manner mode.

15. The method as set forth in claim 13, wherein the at least one value in proportion to the motion of the mobile communication terminal is an average of values output from the motion detection unit for a predetermined period of time.

16. A call alerting method of a mobile communication terminal comprising:
detecting a motion of the mobile communication terminal; and
adjusting the call alerting method based on a predetermined value from the detecting.

17. The call alerting method of claim 16, wherein the adjusting is increasing or decreasing the volume of a ring tone of the mobile communication signal.

18. The call alerting method of claim 16, wherein the adjusting is in creasing or decreasing the intensity of a vibration degree of the mobile communication signal.
